(19) United States
(12) Patent Application Publication
(10) Pub. No.: US 2005/0068347 A1
(43) Pub. Date: Mar. 31, 2005

(54) Three-dimensional image forming method

(75) Inventor: Seiichi Inoue, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/902,267

(22) Filed: Jul. 30, 2004

(30) Foreign Application Priority Data
Jul. 31, 2003 (JP) 2003-204485
Aug. 1, 2003 (JP) 2003-205310

(51) Int. Cl. B41J 1/00

(52) U.S. Cl. 347/5

(57) ABSTRACT

The three-dimensional image forming method prepares two or more kinds of ink, ejects and superimposes the two or more kinds of ink with an ink jet system on a supporting member and forms a three-dimensional image on the supporting member with the two or more kinds of ink ejected and superimposed on the supporting member. Each of two or more kinds of ink contains three-dimensional image forming particles different from each other in diameter. Further, the method forms the three-dimensional image that has been increased in filling factor. Alternatively, two or more kinds of ink contains a first kind of ink containing solid particles and a second kind of ink having physical properties that are different from physical properties of the solid particles.

### BACKGROUND OF THE INVENTION

The present invention relates to a three-dimensional image forming method, and more particularly to a three-dimensional image forming method based on an ink jet system in which a three-dimensional gradation of a three-dimensional image to be formed is compatible with a forming speed of the three-dimensional image. Note that it is assumed that in this specification, the term “image” includes text information, such as letters, as well as general image information.

As is well known, an ink jet recording system is widely used as a recording system that outputs an image, in particular, a color image, using a simple construction and therefore is capable of downsizing an apparatus with ease.

Usually, in a printer based on an ink jet system (hereinafter also referred to as “ink jet printer”), a thermal-head system or an electromechanical conversion element (piezoelectric element) system is used as a recording system and dye-based ink, pigment-based ink, or heat-fusion ink made of a fusible resin-or the like is generally used as a recording liquid used in the ink jet printer. With the recording system, in the case of the dye-based ink, recording (printing) is performed by causing the ink to penetrate into a recording material (such as a recording sheet). Also, in the case of the pigment-based ink, recording (printing) is performed by fixing pigments ejected onto the recording material by means of heat or the like. Further, in the case of the heat-fusion ink, recording (printing) is performed by allowing the fusion ink ejected onto the recording material to solidify.

Meanwhile, an electrostatic drive system that uses pigment-based ink is also proposed. In this electrostatic drive system, recording (printing) is performed by ejecting the pigment-based ink in which charged fine particles are dispersed in a solvent, onto a recording material (such as a recording sheet) by means of an electrostatic force and fixing image dots formed on the recording medium by the charged fine particles onto the recording medium by means of heat or the like.

As a conventional three-dimensional image forming method based on such an ink jet system, for instance, JP 2000-318140 A discloses a print method with an ink jet printer with which multi-printing is simply performed using ink, thereby obtaining a print result having an embossed three-dimensional appearance expressed by undulations (projections and depressions) formed by ink solid matter left on a print target material (material on which a three-dimensional image is to be formed).

In more detail, with this print method, multiple layered planes, whose number of layers corresponds to the number of steps of undulations that should be expressed, are formed by the ink solid matter left on the print target material. Thus, image data is created for each plane in advance. In an example illustrated in FIG. 10, in order to form three layered planes, first image data and fourth image data are created for a first plane, second image data is created for a second plane, and third image data is created for a third plane. Then, ink is ejected by the ink jet printer in accordance with the image data of each plane and the ejected ink is dried and fixed. Multi-printing is performed by repeating this operation for each plane using the ink solid matter.

Also, the fundamental principles of an ink jet recording method based on the electrostatic drive system described above are proposed in a technical document “High Definition Ink-jet Printing with Electrostatic Force” written by Murakami et al. in Journal of the Imaging Society of Japan, Vol. 40, No. 1 (2001), pp. 40 to 47. In this technical document, growing states of a colorant pillar formed on recording paper through continuous ejection of ink droplets at the same position on a recording medium 30 seconds and 60 seconds after the start of the ejection are shown in FIG. 9 in the upper portion of the left column on page 44 and are described between the last line in the right column on page 43 and line 12 in the left column on page 44. Note that the height of this pillar is not disclosed but the disclosed fact is that a pillar having a diameter of around 100 μm was obtained after around 60 seconds from the start of the ejection. The growing states of the colorant pillar formed on the recording paper after 30 seconds and 60 seconds from the start of the ejection are schematically shown in FIGS. 11A, 11B, and 11C.

It should be noted here that the electrostatic ink jet technique disclosed in this technical document is originally aimed at forming a high-resolution image and it is described that with this technique, it becomes possible to record picture dots (image dots) at high resolution of 2000 dpi or more at a frequency of 4 kHz or more and also to control the sizes of the image dots.

Meanwhile, although not a technique of directly forming a three-dimensional image with a recording method based on an ink jet system, as an image forming method that enables expression by three-dimensional protrusions on an image forming target material (material on which an image is to be formed), an image forming method and apparatus based on a heat-fusion transfer recording system is known as disclosed in JP 10-236086 A. With this image forming method based on the heat-fusion transfer recording system, first, a foaming ink image is formed using heat-fusion transfer ink (hereinafter referred to as “foaming ink”), which contains a heat-foaming material that is foamable through application of heat, on an intermediate transfer member with a certain recording method, such as heat-sensitive transfer recording based on a selective heating means like a thermal head or a laser, while preventing the ink from thermally foaming. Then, the foaming ink image formed on the intermediate transfer member is transferred onto an image forming target material by means of heat and pressure. During this heat-pressure transfer, the foaming ink is caused to foam, so that an image having three-dimensional protrusions is formed on the image forming target material.

As described in this document, it is possible to form a three-dimensional image with relative ease using the foaming ink in the heat-fusion transfer recording system.

Each of the documents described above discloses a technique for forming a three-dimensional image using an ink jet system or suggests a possibility of such three-dimensional image formation, although involving problems described below.

First, with the technique as disclosed in JP 2000-318140 A, multi-printing of multiple layered planes is performed by simply repeating, for each plane, ejection of ink containing ink solid matter using the ink jet printer and drying and fixation of the ink. Therefore, although it is possible to form a three-dimensional image, in order to increase the number of levels of height gradation, it is required to increase the number of times the multi-printing is performed in accordance with the increase in the number of levels of gradation. Consequently, there arises a problem in that a too long time is taken by the three-dimensional image formation and it is impossible to create a three-dimensional image at a commercially available speed.

Next, with the technique disclosed in JP 10-236086 A that uses the heat-fusion transfer ink (that is, the foaming ink) containing the heat-foaming material, a possibility of application of the foaming ink to a recording method based on an ink jet system is suggested. For instance, a construction is conceivable in which an image is formed on a recording medium using the heat-fusion transfer ink by ejecting the foaming ink onto an intermediate transfer member using an ink jet printer and transferring the foaming ink onto a recording medium by means of heat and pressure or by directly ejecting the foaming ink onto the recording medium and causing the foaming ink to foam through application of heat. This construction has a possibility that a three-dimensional image, such as an image shown in FIG. 12, is formed through control of the ejection amount of the foaming ink. Note that in FIG. 12, reference numerals 141, 142, and 143 denote projections formed by the foaming ink in respective colors.

In this case, however, the foaming ink expands in an isotropic manner on a recording medium P, so that as is also apparent from FIG. 12, there is a fatal problem in that an aspect ratio of each projection formed is fixed and it is impossible to control a color image and the height gradation of the image independently of each other.

Also, the technical document written by Murakami et al. suggests a possibility of formation of a three-dimensional image, such as three-dimensional images shown in FIGS. 13A and 13B, with the electrostatic ink jet technique through multiple times of ejection. In addition, this document also suggests a possibility of control of image dot sizes and formation of a three-dimensional shape having a high aspect ratio with this technique through multiple times of ejection. Here, FIG. 13A is a schematic diagram showing an actual three-dimensional image to be formed when the technique is applied to the three-dimensional image formation, while FIG. 13B is a schematic diagram showing an actual three-dimensional image to be formed when the technique is applied to the three-dimensional image formation as it is. Note that in FIGS. 13A and 13B, reference numeral 151 denotes particles in the same color.

This technical document, however, merely discloses a model experiment where an injection needle is used as an ejection nozzle and describes the growth of the colorant pillar (see FIGS. 11A to 11C). No specific disclosure concerning three-dimensional image formation is made in the document. Also, on the time scale of 30 seconds or 60 seconds as disclosed in this technical document, there is a problem in that a too long time is taken by the three-dimensional image formation and it is impossible to create a three-dimensional image at a commercially available speed.

Also, this technical document does not disclose control of a color image and the height gradation of the color image independently of each other at the time of the three-dimensional image formation using an ink jet system, nor a gradation setting method for obtaining arbitrary height gradation corresponding to the color image and the like. Accordingly, with this technique, it is impossible to set arbitrary height gradation corresponding to the color image.

Further, in the example shown in FIG. 13B, in order to form four layers, it is required to repeatedly perform recording four times. Consequently, as in the case of JP 2000-31840 A, there is a problem in that a too long time is taken by the three-dimensional image formation and it is impossible to create a three-dimensional image at a commercially available speed. Note that this technical document makes no specific disclosure concerning an increase in the speed of the three-dimensional image formation and the like and it is impossible to increase the speed of the three-dimensional image formation with this technique.

Also, as illustrated in FIG. 13B, the dots of the actually formed three-dimensional image are not superimposed with precision and accuracy, so that the dots are superimposed in an unstable manner and tend to topple over. Consequently, there arises a problem concerning the stability of the formed three-dimensional image. In general, in an ink jet system, control of the impingement points of ink droplets with considerably high accuracy is not always possible, so that there is a problem in that an unstable three-dimensional image as shown in FIG. 13B is thus more likely to be formed.

### SUMMARY OF THE INVENTION

The present invention has been made in view of the circumstances described above and a first object is to solves the problems of the conventional techniques and to enable formation of a three-dimensional image with an ink jet system at a commercially available speed or with high productivity, that is, to provide a three-dimensional image forming method in which a gradation of a three-dimensional image to be formed can be compatible with a forming speed of the three-dimensional image.

A second object of the present invention is to solve the aforementioned problems of the conventional techniques by providing a three-dimensional image forming method which allows -a three-dimensional image having commercially available stability to be formed using an ink jet system,

That is, according to the present invention, it becomes possible to form a three-dimensional image at a commercially available speed, that is, with high productivity using an ink jet system and to form a three-dimensional image having commercially available stability using the ink jet system, which have not been attainable with a conventionally known three-dimensional image forming method using an ink jet system or through application of an ink jet system to a conventionally known three-dimensional image forming method.

In order to attain the first object described above, a first aspect of the present invention provides a method for forming a three-dimensional image by ejecting ink with an ink jet system on a supporting member and superimposing the ejected ink thereon, comprising the steps of preparing two or more kinds of ink that each contain three-dimensional image forming particles different from each other in diameter; ejecting the two or more kinds of ink with the ink jet system on the supporting member; superimposing the ejected two or more kinds of ink on the supporting member; and forming the three-dimensional image on the supporting member with the two or more kinds of ink ejected and superimposed on the supporting member.

Preferably, the two or more kinds of ink comprises a first type of ink containing at least first three-dimensional image forming particles having a large size in the three-dimensional image forming particles different from each other in diameter and a second type of ink containing only second three-dimensional image forming particles having a small size therein smaller than the first three-dimensional image forming particles, and wherein large undulations are formed with the first type of ink and small undulations smaller than the large undulations are formed with the second type of ink.

Preferably, image formation and three-dimensional shape formation are simultaneously performed using the three-dimensional image forming particles.

Preferably, the ink used with the inkjet system contains ink for at least one color, and the ink for at least one color includes the two or more kinds of ink containing the three-dimensional image forming particles different from each other in diameter; and gradation of the three-dimensional image is realized by the three-dimensional image forming particles different from each other in diameter contained in the two or more kinds of ink.

Preferably, the ink used with the inkjet system contains ink for a plurality of colors, one type of ink corresponding to at least one color in the ink for the plurality of colors contains at least first three-dimensional image forming particles having a large size in the three-dimensional image forming particles different from each other in diameter, and other types of ink corresponding to other colors contains only second three-dimensional image forming particles having a small size therein smaller than the first three-dimensional image forming particles, and gradation of the three-dimensional image is realized by the first three-dimensional image forming particles contained in the one type of ink and the second three-dimensional image forming particles contained in the other types of ink.

Preferably, the ink used with the inkjet system includes a third type of ink containing transparent particles having one of a large diameter and a small diameter smaller than the large diameter and a fourth type of ink for at least one color containing the three-dimensional image forming particles having a diameter that is different from the diameter of the transparent particles; and gradation of the three-dimensional image is realized by the transparent particles contained in the third type of ink and the three-dimensional image forming particles contained in the fourth type of ink for at least one color.

Preferably, the three-dimensional image forming particles include transparent particles and at least one kind of color particles selected from the group consisting of cyan particles, magenta particles, yellow particles, and black particles; and the three-dimensional image is formed using the transparent particles and at least one kind of color particles.

Preferably, the three-dimensional image forming particles include at least one kind of color particles selected from the group consisting of cyan particles, magenta particles, yellow particles, and black particles; and the three-dimensional image for reflection observation is formed using at least one kind of color particles.

In order to attain the second object described above, a second aspect of the present invention provides a method for forming a three-dimensional image by ejecting ink with an ink jet system on a supporting member and superimposing the ejected ink thereon, comprising the steps of preparing two or more kinds of ink that each contain three-dimensional image forming particles different from each other in diameter; ejecting the two or more kinds of ink with the ink jet system on the supporting member; superimposing the ejected two or more kinds of ink on the supporting member; and forming the three-dimensional image on the supporting member with the two or more kinds of ink ejected and superimposed on the supporting member, wherein the three-dimensional image formed on the supporting member has been increased in filling factor.

Preferably, in order to form the three-dimensional image increased in filling factor, the three-dimensional image forming particles different from each other in diameter contained in the two or more kinds of ink are arranged in a state of a substantially closest-packed structure.

Preferably, in order to arrange the three-dimensional image forming particles contained in the two or more kinds of ink in a state of a substantially closest-packed structure, a first type of ink containing first pigment particles having a large diameter and a second type of ink containing second pigment particles having a small diameter smaller than the large diameter are used as the two or more kinds of ink.

Further, preferably, when the two or more kinds of ink is ejected and superimposed, after one kind of ink is ejected and superimposed and before subsequent one kind of ink is ejected and superimposed, fixation processing is performed through heating in a non-contact manner.

Moreover, in order to attain the second object described above, a third aspect of the present invention provides a method for forming a three-dimensional image by ejecting ink with an ink jet system on a supporting member and superimposing the ejected ink thereon, comprising the steps of preparing a first kind of ink containing solid particles and a second kind of ink having physical properties that are different from physical properties of the solid particles; ejecting the first and second kinds of ink with the ink jet system on the supporting member; superimposing the ejected first and second kinds of ink on the supporting member; and forming the three-dimensional image on the supporting member with the first and second kinds of ink ejected and superimposed on the supporting member, wherein the three-dimensional image formed on the supporting member has been increased in filling factor.

Preferably, in order to form the three-dimensional image increased in filling factor, the second kind of ink is ejected and accumulated at least once in course of three-dimensional shape formation with the first kind of ink.

Preferably, the first kind of ink comprises pigment-particle-containing ink, and the second kind of ink comprises thermoplastic resin ink that solidifies at room temperature.

It should be noted here that in the present invention, ink defined below is used.

(1) Ink containing large-sized particles: this ink may contain small-sized particles, although it is preferable that the ink does not contain such small-sized particles

(2) Ink containing small-sized particles: this ink refers to ink that contains only small-sized particles and does not contain large-sized particles.

As the ink jet system applied to the three-dimensional image forming method according to the present invention, an electrostatic ink jet system is preferably used which ejects ink in which three-dimensional image forming particles are dispersed, by means of an electrostatic force in a concentrated state, and causes the ink to adhere onto a recording medium.

This application claims priority on Japanese patent applications No. 2003-204485 and No. 2003-205310, the entire contents of which are hereby incorporated by reference. In addition, the entire contents of literatures cited in this specification are incorporated by reference.

### BRIEF DESCRIPTION OF THE DRAWINGS

In the accompanying drawings:

FIG. 1 is a schematic cross-sectional view showing the main portion of an embodiment of a recording apparatus that is applied to the three-dimensional image forming method according to the present invention and uses an ink jet head including an individual electrode portion corresponding to a recording dot;

FIG. 2 is a schematic perspective view showing a schematic construction of the individual electrode portion of the ink jet head shown in FIG. 1;

FIGS. 3A to 3F are each a schematic diagram illustrating an example of a protruding state (height gradation) that is realized with the three-dimensional image forming method according to the present invention using two kinds of ink each containing particles of different diameter;

FIG. 4 is a schematic diagram showing an example of a three-dimensional image formed with a three-dimensional image forming method according to a first aspect of the present invention;

FIG. 5 is a schematic diagram showing another example of the three-dimensional image formed with the three-dimensional image forming method according to the first aspect of the present invention;

FIG. 6 is a schematic diagram showing still another example of the three-dimensional image formed with the three-dimensional image forming method according to the first aspect of the present invention;

FIG. 7 is a schematic diagram showing yet another example of the three-dimensional image formed with the three-dimensional image forming method according to the first aspect of the present invention;

FIG. 8 is a schematic diagram showing an example of a three-dimensional image formed with a three-dimensional image forming method according to a second aspect of the present invention;

FIG. 9 is a schematic diagram showing an example of a three-dimensional image formed with a three-dimensional image forming method according to a third aspect of the present invention;

FIG. 10 is a schematic diagram showing a conventional three-dimensional image forming method;

FIGS. 11A to 11C are each a schematic diagram showing another conventional three-dimensional image forming method;

FIG. 12 is a schematic diagram showing a three-dimensional image formed with still another conventional three-dimensional image forming method; and

FIGS. 13A and 13B are each a schematic diagram showing a three-dimensional image formed with a conventional three-dimensional image forming method.

### DETAILED DESCRIPTION OF THE PREFERRED EMBODIMENTS

The three-dimensional image forming method according to the present invention will now be described in detail based on preferred embodiments illustrated in the accompanying drawings.

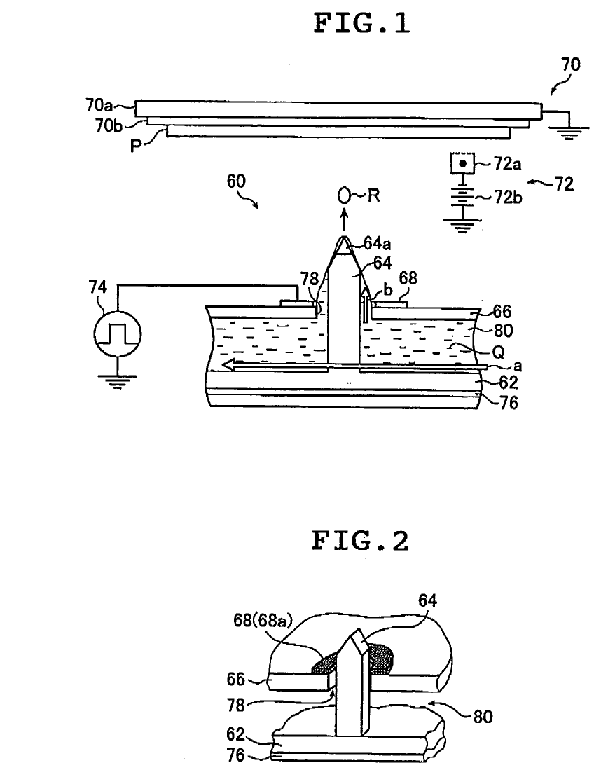

First, a recording apparatus that uses an electrostatic system ink jet head used to implement the three-dimensional image forming method according to the present invention will be described with reference to FIGS. 1 and 2.

FIG. 1 is a schematic cross-sectional view showing the main portion including an individual electrode portion corresponding to a recording dot in an embodiment of the recording apparatus that is usable to implement the three-dimensional image forming method according to the present invention and that uses the electrostatic system ink jet head of line scanning type (hereinafter also simply referred to as “ink jet head”).

The recording apparatus shown in FIG. 1 includes an ink jet head 60, a counter electrode 70 supporting a recording medium P, and a charging unit 72 for charging the recording medium P. The ink jet head 60 records an image corresponding to image data on the recording medium P by causing ink containing a charged fine particle component like pigments (toner or the like, for instance) to be ejected by means of an electrostatic force. To do so, the ink jet head 60 includes a head substrate 62, an ink guide 64, an insulative substrate 66, an ejection electrode 68, a signal voltage source 74, and a floating conduction plate 76.

In the ink jet head 60 in the illustrated example, the ink guide 64 is made of an insulative resin flat plate having a predetermined thickness and including a protrusion-like tip end portion 64a, and is arranged on the head substrate 62 for each individual electrode. In the insulative substrate 66, a through-hole 78 is established at a position corresponding to an arrangement of the ink guide 64. The ink guide 64 passes through the through-hole 78 established in the insulative substrate 66 and its tip end portion 64a protrudes upwardly from the upper surface of the insulative substrate 66 in the drawing, that is, from a surface thereof on a recording medium P side.

It should be noted here that a tip end portion 64a side of the ink guide 64 is formed in a triangular or trapezoidal shape so that it is gradually narrowed in a direction toward a counter electrode 70 side. Here, it is preferable that a metal has been vapor-deposited on the tip end portion (extreme tip end portion) 64a of the ink guide 64 from which ink Q is to be ejected. This metal vapor-deposition has an effect of making the dielectric constant of the tip end portion 64a of the ink guide 64 substantially infinite, making it easy to generate a strong electric field. Also, the shape of the ink guide 64 is not specifically limited so long as it is possible to concentrate the ink Q, in particular, the charged fine particle component in the ink Q in the tip end portion through the through-hole 78 in the insulative substrate 66.

The head substrate 62 and the insulative substrate 66 are arranged so as to be spaced apart from each other by a predetermined distance and an ink flow path 80 functioning as an ink reservoir (ink chamber) for supplying the ink Q to the ink guide 64 is formed between the head substrate 62 and the insulative substrate 66. Note that the ink Q in the ink flow path 80 contains the fine particle component charged to the same polarity as a voltage applied to the ejection electrode 68 and is circulated by a not-shown ink circulation mechanism in a predetermined direction (from the right to the left in the ink flow path 80, in the illustrated example) at a predetermined speed (ink flow of 200 mm/s, for instance) at the time of recording. Hereinafter, a case where coloring particles in the ink are positively charged will be described as an example.

Also, as shown in FIG. 2, the ejection electrode 68 is arranged in a ring manner, that is, as a circular electrode 68a for each individual electrode on the upper surface of the insulative substrate 66 in the drawing, that is, on a surface thereof on the recording medium P side so as to surround the periphery of the through-hole 78 established in the insulative substrate 66. The ejection electrode 68 is connected to the signal voltage source 74 that generates a pulse signal (predetermined pulse voltage) corresponding to ejection data (ejection signal) such as image data or print data.

The counter electrode 70 is arranged at a position opposing the tip end portion 64a of the ink guide 64 and includes a grounded electrode substrate 70a and an insulation sheet 70b arranged on the lower surface of the electrode substrate 70a in the drawing, that is, on a surface thereof on the ink guide 64 side. Also, the recording medium P is supported by the lower surface of the counter electrode 70 in the drawing, that is, on a surface thereof on the ink guide 64 side, in other words, on a surface of the insulation sheet 70b, and is electrostatically adsorbed on the surface, for instance. The counter electrode 70 (insulation sheet 70b) functions as a platen of the recording medium P.

Here, at least at the time of recording, the surface of the insulation sheet 70b of the counter electrode 70, that is, the recording medium P is maintained by the charging unit 72 in a state of being charged to a predetermined negative high voltage having a polarity opposite to the high voltage (pulse voltage) applied to the ejection electrode 68. As a result, the recording medium P is negatively charged by the charging unit 72, is constantly biased to the negative high voltage with respect to the ejection electrode 68, and is electrostatically adsorbed on the insulation sheet 70b of the counter electrode 70.

The charging unit 72 includes a scorotron charger 72a that charges the recording medium P to the negative high voltage and a bias voltage source 72b that supplies the negative high voltage to the scorotron charger 72a. Note that a charging means of the charging unit 72 used in the present invention is not limited to the scorotron charger 72a described above and it is also possible to use various other discharge means such as a corotron charger, a solid charger, and a discharge needle.

It should be noted here that in the illustrated example, the counter electrode 70 is constructed using the electrode substrate 70a and the insulation sheet 70b and the recording medium P is charged to the negative high voltage by the charging unit 72, thereby causing the recording medium P to be electrostatically adsorbed on the surface of the insulation sheet 70b. However, the present invention is not limited to this and the counter electrode 70 may be constructed using only the electrode substrate 70a and the counter electrode 70 (electrode substrate 70a itself) may be connected to a bias voltage source that generates a negative high voltage.

Also, the floating conduction plate 76 is arranged below the ink flow path 80 and is set under an electrically insulated state (high-impedance state). In the illustrated example, the floating conduction plate 76 is arranged inside the head substrate 62. With this floating conduction plate 76, at the time of image recording, an induced voltage is generated in accordance with the value of a voltage applied to the individual electrode and the fine particle component in the ink Q in the ink flow path 80 is caused to migrate to the insulative substrate 66 side to be concentrated. Consequently, it is required that the floating conduction plate 76 is arranged on the head substrate 62 side with respect to the ink flow path 80. Also, it is preferable that the floating conduction plate 76 is arranged on an upstream side of the ink flow path 80 with respect to the position of the individual electrode.

With this floating conduction plate 76, the concentration of the charged particles in an upper layer in the ink flow path 80 is increased. As a result, it becomes possible to increase the concentration of the charged fine particle component in the ink Q passing through the through-hole 78 of the insulative substrate 66, to cause the charged fine particle component to be concentrated in the tip end portion 64a of the ink guide 64, and to maintain the concentration of the charged fine particle component in the ink Q ejected as an ink droplet R at a predetermined level.

Also, the induced voltage generated by the floating conduction plate 76 changes in accordance with the number of operating channels. Consequently, even if a voltage to the floating conduction plate 76 is not controlled, charged particles required for ejection is supplied, which makes it possible to prevent clogging. Note that a power source may be connected to the floating conduction plate 76 and a predetermined voltage may be applied thereto.

The ink jet head 60 according to this embodiment and the recording apparatus using the ink jet head 60 are constructed fundamentally in the manner described above. Next, operations of the ink jet head and the recording apparatus will be described.

In the ink jet head 60 shown in FIG. 1, at the time of recording, the ink Q containing the fine particles charged to the same polarity as the voltage applied to the ejection electrode 68 (positive (+) in this example) is circulated by a not-shown ink circulation mechanism including a pump in the ink flow path 80 in a direction of an arrow “a” in FIG. 1, that is, in a direction from the right to the left. When doing so, the recording medium P electrostatically adsorbed on the counter electrode 70 is charged to a reversed polarity, that is, to a negative high voltage (−1500 V, for instance). Also, the floating conduction plate 76 is set under an insulated state (high-impedance state).

Here, when no pulse voltage is applied to the ejection electrode 68 or when the pulse voltage applied to the ejection electrode 68 is set at a low voltage level (0 V), a voltage (potential difference) between the ejection electrode 68 and the counter electrode 70 (recording medium P) becomes equal to a bias voltage (1500 V, for instance) and the electric field strength in proximity to the tip end portion 64a of the ink guide 64 becomes low. Consequently, the ink Q will not fly out from the tip end portion 64a of the ink guide 64, that is, will not be ejected as the ink droplet R. Under this state, however, a part of the ink Q in the ink flow path 80, in particular, the charged fine particle component contained in the ink Q moves in a direction of an arrow “b” in FIG. 1, that is, in a direction from the lower side of the insulative substrate 66 to the upper side thereof while passing through the through-hole 78 in the insulative substrate 66 by migration action, capillary action, or the like and is concentrated in the tip end portion 64a of the ink guide 64.

On the other hand, when a pulse voltage at a high voltage level (400 to 600 V, for instance) is applied to the ejection electrode 68, a voltage (400 to 600 V, for instance) that is equal to the applied pulse voltage is superimposed on the bias voltage (1500 V, for instance). Therefore, the voltage (potential difference) between the ejection electrode 68 and the counter electrode 70 (recording medium P) is increased to 1900 to 2100 V, so that the electric field strength in proximity to the tip end portion 64a of the ink guide 64 is increased. Under this state, the ink Q which moved upward along the ink guide 64 and reached the tip end portion 64a above the insulative substrate 66, in particular, the charged fine particle component concentrated in the ink Q flies out from the tip end portion 64a of the ink guide 64 as the ink droplet R containing the charged fine particle component by means of an electrostatic force, is attracted by the counter electrode 70 (recording medium P) biased to the negative high voltage (−1500 V, for instance), and adheres onto the recording medium P.

By ejecting the ink in this manner in accordance with image data and forming and recording dots on the recording medium P while relatively moving the ink jet head 60 in this embodiment and the recording medium P supported on the counter electrode 70, an image corresponding to the image data is recorded on the recording medium P.

It should be noted here that in the ink jet head 60 of this embodiment described above, a mono-layered structure is adopted in which the circular electrode 68a is arranged only on the upper surface of the insulative substrate 66, although the present invention is not limited to this and it is possible to use instead a two-layered structure where the ejection electrode 68 is arranged on both surfaces of the insulative substrate 66 (that is, the upper surface and the lower surface thereof).

Hereinabove, the fundamentals of the recording operation in the embodiment of the recording apparatus used to implement the three-dimensional image forming method according to the present invention and using the electrostatic system ink jet head of line scanning type have been described. Next, the three-dimensional image forming method according to the present invention will be described in a specific manner.

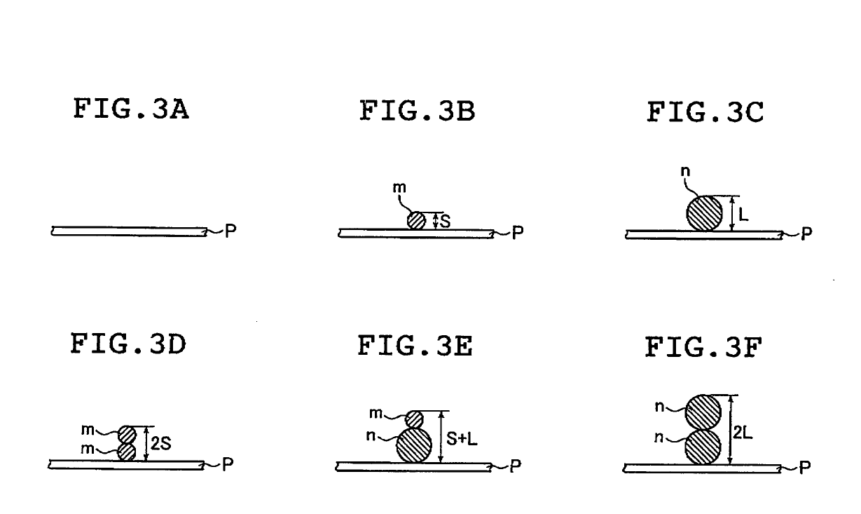

First, a three-dimensional image forming method according to a first aspect of the present invention will be described with reference to FIGS. 3A to 7.

The three-dimensional image forming method according to the first aspect of the present invention is characterized in that two or more kinds of ink, which each contain three-dimensional image forming particles (hereinafter also simply referred to as “particles”) and are fundamentally different from each other in diameter of the particles contained therein, are used as the charged fine particle component (such as pigments) in the recording apparatus illustrated in FIG. 1, for instance.

In more detail, with the three-dimensional image forming method according to the first aspect of the present invention, even when ink for a single color is used, two or more kinds of ink that are different from each other in diameter of particles contained therein are prepared and “overstriking” onto a recording medium is performed using these ink in succession, thereby forming an image having various protruding states (that is, having a three-dimensional shape) on a surface of the recording medium.

Here, if two kinds of ink, which each contain particles different from each other in diameter, are prepared as the ink for a single color (note that it is assumed that when the diameter of small-sized particles m is referred to as “S” and the diameter of large-sized particles n is referred to as “L”, a relation of “S>(1/2)L” is satisfied), for instance, it becomes possible to at least express protruding states corresponding to respective heights described below (see FIGS. 3A to 3F).
(a) height=0 (see FIG. 3A)
(b) height=S: height corresponding to the diameter of one small-sized particle m (see FIG. 3B)
(c) height=L: height corresponding to the diameter of one large-sized particle n (see FIG. 3C)
(d) height=2S: height corresponding to a state where two small-sized particles m are stacked on each other (see FIG. 3D)
(e) height=S+L: height corresponding to a state where one small-sized particle m and one large-sized particle n are stacked on each other (see FIG. 3E)
(f) height-2L: height corresponding to a state where two large-sized particles n are stacked on each other (see FIG. 3F)

The examples described above are each a situation achieved by performing recording twice using the ink (m′) containing the small-sized particles m and performing recording twice using the ink (n′) containing the large-sized particles n (that is, performing recording four times in total). Here, it is sufficient that the number of repetitions of the recording is determined in accordance with the number of levels of the height gradation of an image that should be expressed. Note that depending on the number of levels of the height gradation that should be expressed, there is a case where it is not required to perform the repetition for every combination, which makes it possible to reduce the number of repetitions of the recording. This is an advantage of the present invention.

It should be noted here that in the case of color recording using color ink in three or more colors, the repetitive recording described above is performed for each color. The recording order in this case is not specifically limited and may be determined as appropriate. For instance, recording in a certain color may be repeatedly performed for each particle size and then the processing may proceed to recording in another color. Alternatively, recording in each color may be performed for a certain particle size and the particle size may be changed in succession.

Also, it is possible to additionally use particles (clear particles) made of a transparent material as the particles. In this case, the clear particles are used only to form the protruding portions described above (that is, to form the three-dimensional shape) and, after the formation of the protrusion portions, coloring (that is, conversion into an image) is performed using ink in predetermined colors. This construction has an advantage that it becomes possible to use particles made of relatively low-priced materials.

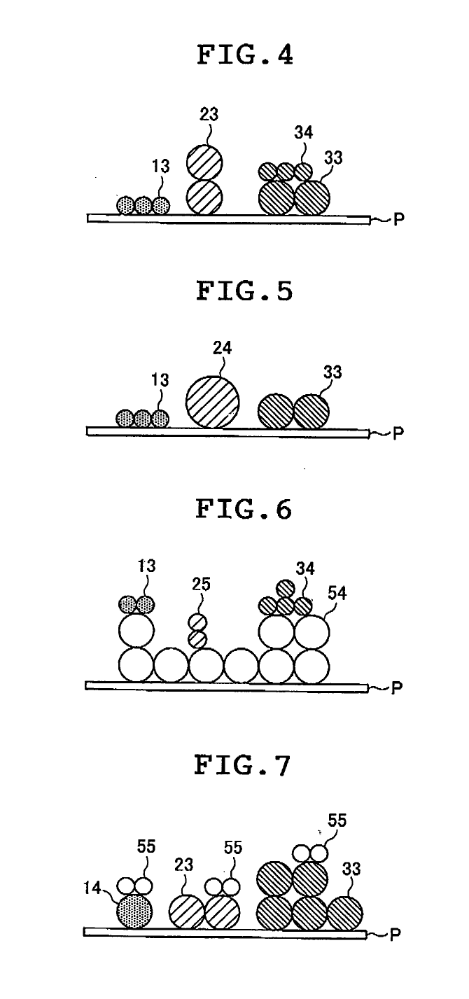

Next, various specific forming examples of a three-dimensional image formed with the three-dimensional image forming method according to the first aspect of the present invention will be described with reference to FIGS. 4 to 7. Note that in each following example, two or three kinds of ink are prepared for each color. In the case of the two kinds of ink, ink containing large-sized particles and ink containing small-sized particles are prepared for each color (ratio between them is set at “2:1”). In a like manner, in the case of the three kinds of ink, ink containing large-sized particles, ink containing middle-sized particles, and ink containing small-sized particles are prepared for each color (ratio among them is set at “3:2:1”). Also, in each following example, a case of color recording using color ink in three colors will be described. In FIG. 4, for instance, a first color, a second color, and a third color are illustrated in this order from the left side-(the same applies to FIGS. 5 to 7).

In the forming example shown in FIG. 4, only ink containing the small-sized particles 13 is used for the first color and only ink containing the large-sized particles 23 is used for the second color, although both of ink containing the large-sized particles 33 and ink containing the small-sized particles 34 are used for the third color. Consequently, the height gradation shown in FIG. 4 is expressed by performing recording fives times in total (this is because recording is performed twice using the same ink for the second color).

Incidentally, when this height gradation is expressed using the conventional method disclosed in the technical document by Murakami et al., as is also apparent from FIG. 13A, it is required to perform recording eight times in total (once for the first color, four times for the second color, and three times for the third color).

When the number of times of recording is increased as in this case, a recording time taken to record a three-dimensional image is elongated accordingly, which goes against the object of the present invention to increase the speed of three-dimensional image formation.

In the forming example shown in FIG. 5, only the ink containing the small-sized particles 13 is used for the first color, only the ink containing the large-sized particles 24 is used for the second color, and only the ink containing the middle-sized particles 33 are used for the third color. Consequently, the height gradation shown in FIG. 5 is expressed by performing recording three times in total (this is because recording is performed once for each color).

Also in this case, when this height gradation is expressed using the conventional method disclosed in the above-mentioned technical document, as is also apparent from FIG. 13A, it is required to perform recording six times in total (once for the first color, three times for the second color, and twice for the third color).

In contrast, in this forming example, it is required to perform recording only three times, so that the time necessary for the three-dimensional image formation is reduced to substantially half, which largely contributes to higher-speed image formation.

Also, in the forming example shown in FIG. 6, large-sized clear particles are used complementarily. That is, in the forming example shown in FIG. 6, a method is used with which after height gradation is roughly formed using large-sized clear particles 54 (using ink containing these particles), fine height gradation is formed using the small-sized particles 13, 25, and 34 (using ink containing the particles for each color).

In this example, by performing recording seven times in total (twice for the clear color, once for the first color, twice for the second color, and twice for the third color), the height gradation shown in FIG. 6 having a lot of changes is expressed.

When this height gradation is expressed with the method disclosed in the aforementioned technical document, as is apparent from FIG. 13A, it is required to perform recording nine times in total (four times for the clear color, once for the first color, twice for the second color, and twice for the third color).

Also, in the forming example shown in FIG. 7, small-sized clear particles are used complementarily in an opposite manner to the forming example shown in FIG. 6. That is, in the forming example shown in FIG. 7, a method is used with which after height gradation is formed using large-sized particles 14, 23, and 33 for each color (using ink containing these particles), fine height gradation is formed using the small-sized clear particles 55 (using ink containing the particles).

In this example, by performing recording five times in total (once for the first color, once for the second color, twice for the third color, and once for the clear color), the height gradation shown in FIG. 7 having a lot of changes as in the example shown in FIG. 6 is expressed.

When this height gradation is expressed with the method disclosed in the aforementioned technical document, as is apparent from FIG. 13A, it is required to perform recording nine times in total (twice for the first color, twice for the second color, four times for the third color, and once for the clear color).

In each forming example described above, the number of times of recording is decreased by around 50% to 23% as compared with the conventional case and the speed of three-dimensional image formation is improved. Also, the construction where multiple kinds-of ink containing particles having different sizes are used has an advantage that it also becomes possible to achieve preferable expression in terms of the height gradation of a three-dimensional image to be formed while improving the forming speed of the three-dimensional image.

The three-dimensional image forming method according to the first aspect of the present invention is fundamentally constructed in the manner described above.

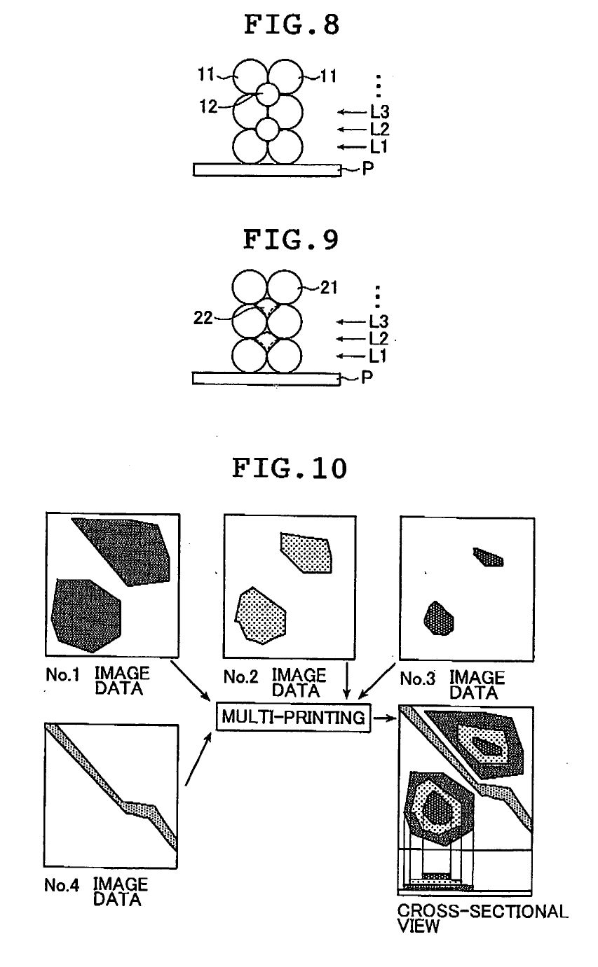

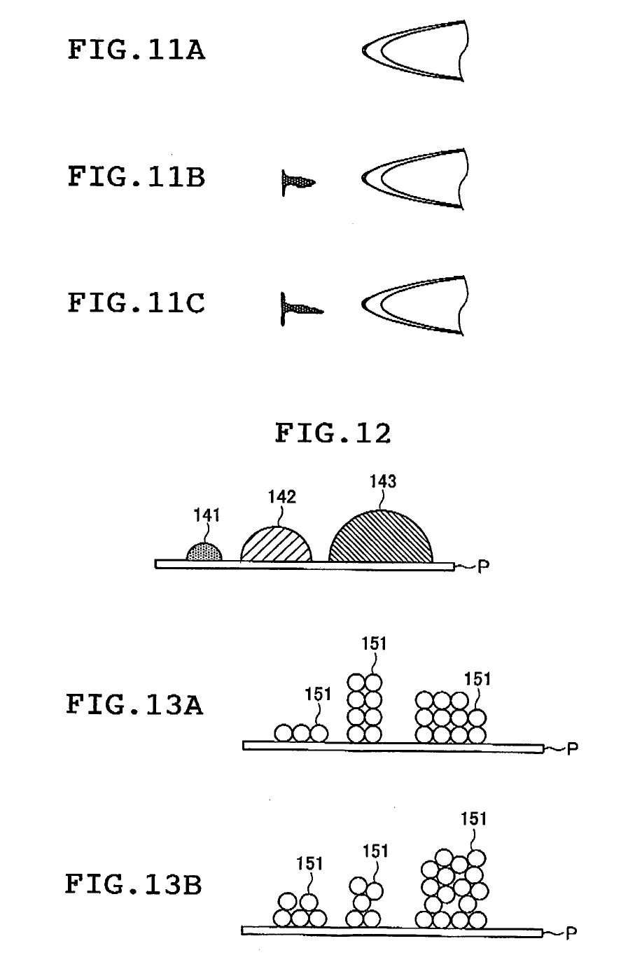

Next, a three-dimensional image forming method according to a second aspect of the present invention and a three-dimensional image forming method according to a third aspect of the present invention will be described with reference to FIGS. 8 and 9.

The three-dimensional image forming method according to the second aspect of the present invention is characterized in that two or more kinds of ink, which each contain three-dimensional image forming particles (particles) different from each other in diameter, are fundamentally used as the charged fine particle component (such as pigments) in the recording apparatus shown in FIG. 1, for instance. On the other hand, the three-dimensional image forming method according to the third aspect of the present invention is characterized in that ink containing solid particles and ink having physical properties that are different from those of the solid particles are fundamentally used as the charged fine particle component in the recording apparatus.

In more detail, with the three-dimensional image forming method according to the second aspect of the present invention, even when ink for a single color is used, for instance, two or more kinds of ink, which each contain particles different from each other in diameter, are prepared and “overstriking” is performed on a recording medium using the two or more kinds of ink in succession, thereby forming, on a surface of the recording medium, an image having various protruding states (that is, having a three-dimensional shape) where the filling factor of the particles has been increased.

On the other hand, with the three-dimensional image forming method according to the third aspect of the present invention, when a three-dimensional image in a single color is formed, “overstriking” is performed on a recording medium using in succession the ink containing the solid particles and thermoplastic resin ink that does not contain solid particles and solidifies at room temperature, thereby forming an image having a three-dimensional shape where the filling factor of the particles has been increased as in the case of the second aspect described above.

Next, specific forming examples (embodiments) where three-dimensional images are formed with the three-dimensional image forming methods according to the second and third aspects of the present invention will be described in various ways.

First, as an example relating to the second aspect of the present invention, a case will be described in which two kinds of ink, which each contain particles different from each other in size (size ratio between large particles and small particles will be described in detail later), are prepared for each color and a three-dimensional image is formed using the ink.

FIG. 8 shows a forming example where a three-dimensional image is formed with the three-dimensional image forming method according to the second aspect of the present invention through alternate ejection of two kinds of ink in the same color one of which contains large-sized particles 11 and the other of which contains small-sized particles 12. In this example, a first layer (L1) is first formed using the ink containing the large-sized particles 11, a second layer (L2) is next formed using the ink containing the small-sized particles 12 on the first layer (L1) by shifting the ejection position of the ink by one half of the diameter of the large-sized particles 11, and a third layer (L3) is further formed using the ink containing the large-sized particles 11 on the second layer (L2) by shifting the ejection position of the ink by one half of the diameter of the large-sized particles 11. By repeating this procedure, a three-dimensional image is formed.

In FIG. 8, the three-dimensional image is formed by ejecting each kind of ink in succession to arrange the small-sized particle 12 forming the second layer (L2) on the large-sized particles 11 forming the first layer (L1) arranged in a square shape so that the small-sized particle 12 is positioned at the upper central portion of the square and then arrange the large-sized particles 11 constituting the third layer (L3) in a square shape so that the small-sized particle 12 is surrounded by the particles 11. In this manner, a three-dimensional image having a physically solid structure is formed.

That is, by arranging the small-sized particle 12 constituting the second layer (L2) at the center of the square shape of the first layer (L1) formed by the large-sized particles 11, it becomes possible to hold the third layer (L3) having the same structure as the first layer (that is, formed by the large-sized particles 11 and having a square shape) on the second layer (L2) As regards the structure of layers above the third layer, by forming each layer according to this method, it becomes possible to prevent displacements of the layers as well.

Here, it is preferable that a relation “small particle diameter <(large particle diameter/2)” is established between the size of the large-sized particles 11 and the size of the small-sized particles 12 used in the embodiment described above.

It should be noted here that in the embodiment described above, a case where two kinds of ink, one of which contains large-sized particles and the other of which contains small-sized particles, are used in combination has been described. However, it is also possible to form a three-dimensional image having more levels of gradation using three or more particle sizes in combination, although the selection (combination) of the particle sizes is complicated to some extent.

Here, it is possible to apply a so-called fine filling theory to the particles having different diameters and the arrangement thereof described in the above embodiment. In this case, it becomes possible to realize a preferable particle arrangement through combination of a recording head ink droplet ejection position adjustment (control) technique and particle sizes determined based on the fine filling theory.

Next, as an embodiment according to the third aspect of the present invention, an example will be described in which a three-dimensional image in a single color is formed by performing “overstriking” on a recording medium using ink containing solid particles and thermoplastic resin ink that does not contain solid particles and solidifies at room temperature in succession. In this example, the ink containing the particles having a certain size for each color and the thermoplastic resin ink that does not contain solid particles and solidifies at room temperature are prepared for the same color and a three-dimensional image is formed using the ink.

A three-dimensional image shown in FIG. 9 is formed by repeating a procedure where the first layer (L1) is first formed using the ink containing the particles 21, the second layer (L2) is next formed on the first layer (L1) by ejecting the ink not containing the particles by shifting the ejection position of the ink by one half of the diameter of the particles 21, and the third layer (L3) is further formed on the second layer (L2) using the ink containing the particles 21 by shifting the ejection position of the ink by one half of the diameter of the particles 21.

Here, in FIG. 9, reference numeral 22 denotes particles (coagulated matter) indefinite in shape that were formed by ejecting the thermoplastic resin ink described above, allowing the ink to flow to some extent at its impingement position, and then allowing the ink to solidify.

In completely the same manner as in the case of the small-sized particles 12 in the embodiment of the second aspect described above, each kind of ink is ejected in succession to arrange the particle (coagulated matter) 22 forming the second layer (L2) on the large-sized particles 11 forming the first layer (L1) in a square shape so that the particle 22 is positioned at the upper central portion of the square and then arrange the particles 21 constituting the third layer (L3) in a square shape so as to surround the particle (coagulated matter) 22. With this forming method, a three-dimensional image having a physically solid structure is formed.

According to each embodiment described above, solid particles or coagulated particles that are capable of achieving substantially the same effect as the solid particles through solidification after ejection are used, so that it becomes possible to form a physically solid three-dimensional image mainly using the three-dimensional image forming particles (particles 11 and 21 in the embodiments described above).

The three-dimensional image forming methods according to the second and third aspects of the present invention are fundamentally constructed in the manner described above.

As described in detail above, the first aspect of the present invention is markedly effective in that a three-dimensional image can be formed with high productivity, that is, a three-dimensional image forming method in which the gradation of a three-dimensional image to be formed is compatible with the forming speed of the three-dimensional image can be provided.

Also, as described in detail above, the second and third aspects of the present invention are also markedly effective in that a three-dimensional image forming method can be realized with which a three-dimensional image having high stability can be formed using an ink jet system.

It should be noted here that the embodiment of each aspect of the present invention is merely presented as an example of the present invention and the present invention should not be construed as being limited to the embodiment. That is, it is of course possible to make changes and modifications as appropriate without departing from the gist of the present invention.

For instance, in course of three-dimensional image formation according to the present invention, in particular, the second and third aspects of the present invention, each time one layer is laminated by ejecting ink, the whole may be subjected to heat-fixation in a non-contact manner. In this case, a three-dimensional image under formation is subjected to fixation each time a layer is laminated, so that it becomes possible to attain a solid structure.

1. A method for forming a three-dimensional image by ejecting ink with an ink jet system on a supporting member and superimposing the ejected ink thereon, comprising the steps of:
preparing two or more kinds of ink that each contain three-dimensional image forming particles different from each other in diameter;
ejecting said two or more kinds of ink with said ink jet system on said supporting member;
superimposing said ejected two or more kinds of ink on said supporting member; and
forming said three-dimensional image on said supporting member with said two or more kinds of ink ejected and superimposed on said supporting member.

2. The three-dimensional image forming method according to claim 1,
wherein said two or more kinds of ink comprises a first type of ink containing at least first three-dimensional image forming particles having a large size in said three-dimensional image forming particles different from each other in diameter and a second type of ink containing only second three-dimensional image forming particles having a small size therein smaller than said first three-dimensional image forming particles, and
wherein large undulations are formed with said first type of ink and small undulations smaller than said large undulations are formed with said second type of ink.

3. The three-dimensional image forming method according to claim 1,
wherein image formation and three-dimensional shape formation are simultaneously performed using said three-dimensional image forming particles.

4. The three-dimensional image forming method according to claim 1, wherein
said ink used with said inkjet system contains ink for at least one color, and said ink for at least one color includes said two or more kinds of ink containing said three-dimensional image forming particles different from each other in diameter; and
gradation of said three-dimensional image is realized by said three-dimensional image forming particles different from each other in diameter contained in said two or more kinds of ink.

5. The three-dimensional image forming method according to claim 1, wherein
said ink used with said inkjet system contains ink for a plurality of colors,
one type of ink corresponding to at least one color in said ink for said plurality of colors contains at least first three-dimensional image forming particles having a large size in said three-dimensional image forming particles different from each other in diameter, and other types of ink corresponding to other colors contains only second three-dimensional image forming particles having a small size therein smaller than said first three-dimensional image forming particles, and
gradation of said three-dimensional image is realized by said first three-dimensional image forming particles contained in said one type of ink and said second three-dimensional image forming particles contained in said other types of ink.

6. The three-dimensional image forming method according to claim 1, wherein
said ink used with said inkjet system includes a third type of ink containing transparent particles having one of a large diameter and a small diameter smaller than said large diameter and a fourth type of ink for at least one color containing the three-dimensional image forming particles having a diameter that is different from the diameter of said transparent particles; and
gradation of said three-dimensional image is realized by said transparent particles contained in said third type of ink and said three-dimensional image forming particles contained in said fourth type of ink for said at least one color.

7. The three-dimensional image forming method according to claim 1, wherein
said three-dimensional image forming particles include transparent particles and at least one kind of color particles selected from the group consisting of cyan particles, magenta particles, yellow particles, and black particles; and
said three-dimensional image is formed using said transparent particles and said at least one kind of color particles.

8. The three-dimensional image forming method according to claim 1, wherein
said three-dimensional image forming particles include at least one kind of color particles selected from the group consisting of cyan particles, magenta particles, yellow particles, and black particles; and
said three-dimensional image for reflection observation is formed using said at least one kind of color particles.

9. A method for forming a three-dimensional image by ejecting ink with an ink jet system on a supporting member and superimposing the ejected ink thereon, comprising the steps of:
preparing two or more kinds of ink that each contain three-dimensional image forming particles different from each other in diameter;
ejecting said two or more kinds of ink with said ink jet system on said supporting member;
superimposing said ejected two or more kinds of ink on said supporting member; and
forming said three-dimensional image on said supporting member with said two or more kinds of ink ejected and superimposed on said supporting member,
wherein said three-dimensional image formed on said supporting member has been increased in filling factor.

10. The three-dimensional image forming method according to claim 9,
wherein, in order to form said three-dimensional image increased in filling factor, said three-dimensional image forming particles different from each other in diameter contained in said two or more kinds of ink are arranged in a state of a substantially closest-packed structure.

11. The three-dimensional image forming method according to claim 10,
wherein, in order to arrange said three-dimensional image forming particles contained in said two or more kinds of ink in a state of a substantially closest-packed structure, a first type of ink containing first pigment particles having a large diameter and a second type of ink containing second pigment particles having a small diameter smaller than said large diameter are used as said two or more kinds of ink.

12. The three-dimensional image forming method according to claim 9,
wherein, when said two or more kinds of ink is ejected and superimposed, after one kind of ink is ejected and superimposed and before subsequent one kind of ink is ejected and superimposed, fixation processing is performed through heating in a non-contact manner.

13. A method for forming a three-dimensional image by ejecting ink with an ink jet system on a supporting member and superimposing the ejected ink thereon, comprising the steps of:
preparing a first kind of ink containing solid particles and a second kind of ink having physical properties that are different from physical properties of said solid particles;
ejecting said first and second kinds of ink with said ink jet system on said supporting member;
superimposing said ejected first and second kinds of ink on said supporting member; and
forming said three-dimensional image on said supporting member with said first and second kinds of ink ejected and superimposed on said supporting member,
wherein said three-dimensional image formed on said supporting member has been increased in filling factor.

14. The three-dimensional image forming method according to claim 13,
wherein, in order to form said three-dimensional image increased in filling factor, said second kind of ink is ejected and accumulated at least once in course of three-dimensional shape formation with said first kind of ink.

15. The three-dimensional image forming method according to claim 13,
wherein said first kind of ink comprises pigment-particle-containing ink, and said second kind of ink comprises thermoplastic resin ink that solidifies at room temperature.
